(19) United States
(12) Patent Application Publication
(10) Pub. No.: US 2026/0323157 A1
(43) Pub. Date: Oct. 15, 2026

(54) INFORMATION PROCESSING APPARATUS, IMAGING APPARATUS, CONTROL METHODS THEREOF, AND NON-TRANSITORY COMPUTER-READABLE STORAGE MEDIUMS

(71) Applicant: CANON KABUSHIKI KAISHA, Tokyo (JP)

(72) Inventor: HIROMU FURUKAWA, Kanagawa (JP)

(21) Appl. No.: 19/571,665

(22) Filed: Mar. 19, 2026

(30) Foreign Application Priority Data
Apr. 10, 2025 (JP) 2025-065200

(51) Int. Cl. H04N 23/661; G06F 3/04817; G06F 3/0482; G06T 3/40; H04N 23/60

(52) U.S. Cl. CPC H04N 23/661; G06F 3/04817; G06F 3/0482; G06T 3/40; H04N 23/64

(57) ABSTRACT

An information processing apparatus comprising: a receiving unit configured to receive one or more public shooting settings; a management unit configured to store in a storage unit and manage the one or more public shooting settings; a decision unit configured to, in a case where a new public shooting setting is received by the receiving unit and added to the storage unit, decide an imaging apparatus to which information regarding the new public shooting setting is to be distributed based on a distribution condition; and a distribution unit configured to perform distribution to the imaging apparatus decided by the decision unit.

### BACKGROUND

### Field of the Technology

The present disclosure relates to an information processing apparatus, an imaging apparatus, control methods thereof, and a non-transitory computer-readable storage mediums.

### Description of the Related Art

In recent years, it has become possible to easily transfer images captured by an imaging apparatus such as a digital camera to a server apparatus via wireless communication.

In this type of server apparatus, for the purpose of promoting the use of imaging apparatuses, sample images, setting values at the time of shooting, setting values for developing, and the like are often collectively provided as public shooting settings along with an introduction of shooting techniques. When a user selects a favorite public shooting setting, the user can download various setting values to the imaging apparatus, and can perform shooting similar to the sample image.

Japanese Patent Application Laid-Open No. 2003-333498 discloses a method in which a distribution apparatus that records sample image data and a shooting condition thereof searches for a sample image based on a search condition from an imaging apparatus, and distributes the shooting condition of the search result to the imaging apparatus to allow the imaging apparatus to perform shooting.

However, when a shooting setting matching a user's preference is newly made public, there are cases where the user wants to check the new shooting setting on the imaging apparatus and use it for shooting without performing an additional operation. In that case, with the technique described in Japanese Patent Application Laid-Open No. 2003-333498, the user cannot know that a new shooting setting has been made public, and it is necessary to send a search condition every time to acquire the shooting setting.

### SUMMARY

The present disclosure has been made in view of the above problems, and provides a technique for easily using a new shooting setting.

According to one aspect of the present disclosure, there is provided an information processing apparatus comprising: a receiving unit configured to receive one or more public shooting settings; a management unit configured to store in a storage unit and manage the one or more public shooting settings; a decision unit configured to, in a case where a new public shooting setting is received by the receiving unit and added to the storage unit, decide an imaging apparatus to which information regarding the new public shooting setting is to be distributed based on a distribution condition; and a distribution unit configured to perform distribution to the imaging apparatus decided by the decision unit.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a diagram showing a configuration example of an information processing system according to one embodiment.

FIG. 2 is a diagram showing a hardware configuration example of each apparatus according to one embodiment.

FIG. 3 is a functional configuration diagram according to the first embodiment.

FIG. 4 is a diagram showing an example of a shooting setting list screen according to one embodiment.

FIG. 5 is a diagram showing an example of a shooting setting confirmation screen according to one embodiment.

FIG. 6 is a diagram showing an example of a shooting setting utilization screen according to one embodiment.

FIG. 7 is a diagram showing a functional configuration example in the second embodiment.

FIG. 8 is a diagram showing a functional configuration example in the third embodiment.

FIG. 9 is a diagram showing an example of a shooting assistance display on a shooting setting utilization screen according to one embodiment.

FIG. 10 is a diagram showing an example of a processing sequence in an information processing system according to one embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

### System Configuration

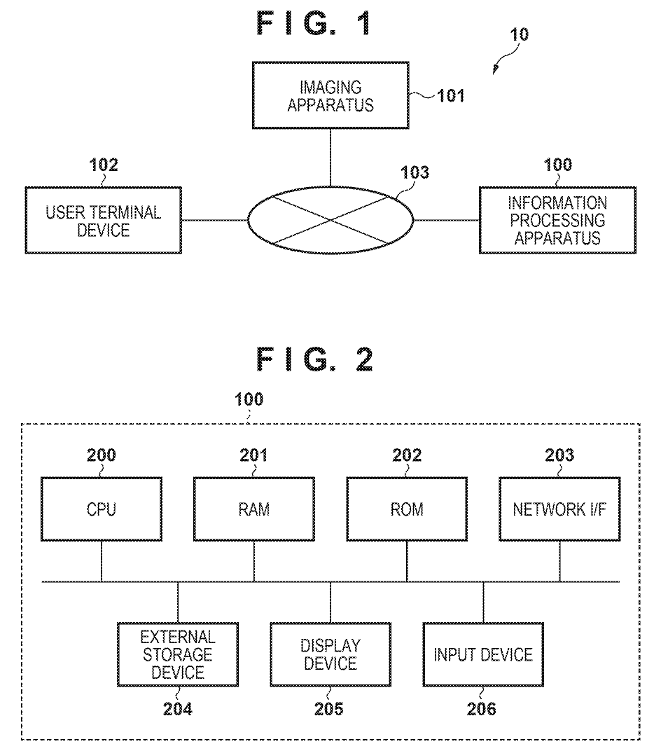

First, a configuration example of an information processing system according to the present embodiment will be described with reference to FIG. 1. The information processing system 10 includes an information processing apparatus 100, an imaging apparatus 101, and a user terminal device 102, and the respective devices are capable of communicating with each other via a network 103. The information processing apparatus 100, the imaging apparatus 101, and the user terminal device 102 may be configured by a plurality of units. Also, the information processing system 10 may be configured to include the information processing apparatus 100 and the imaging apparatus 101.

The information processing apparatus 100 is, for example, a server apparatus, and receives and records a public shooting setting from the user terminal device 102. Further, it distributes the shooting setting to the imaging apparatus 101. The imaging apparatus 101 is an information processing apparatus having a shooting function and a communication function owned by a user, and is, for example, a digital camera. The user terminal device 102 is an information processing apparatus having a communication function owned by a user, and is, for example, a mobile phone, a smartphone, a PC, a tablet terminal, or the like. The network 103 may be the same network such as a LAN, may be an external network such as the Internet, or may be a mixture thereof.

### Hardware Configuration

Next, the hardware configuration of each apparatus constituting the information processing system 10 according to the present embodiment will be described. First, a hardware configuration example of the information processing apparatus 100 according to the present embodiment will be described with reference to the block diagram of FIG. 2.

The information processing apparatus 100 includes a CPU 200, a RAM 201, a ROM 202, a network interface 203, an external storage device 204, a display device 205, and an input device 206. The CPU 200 performs operation control of each part constituting the information processing apparatus 100, and also serves as an agent that executes various processes described later as being performed by the information processing apparatus 100. The RAM 201 is a memory that temporarily stores data and control information, and serves as a work area used when the CPU 200 executes various processes.

Fixed operation parameters, operation programs, and the like of the information processing apparatus 100 are stored in the ROM 202. The network interface 203 provides a function for connecting to the network 103 and communicating. The information processing apparatus 100 can perform data transmission and reception with an external device via this network interface 203.

The external storage device 204 is a device that stores data and has an interface that receives I/O commands for reading and writing data. The external storage device 204 may be a hard disk drive (HDD), a solid state drive (SSD), an optical disk drive, a semiconductor storage device, or another storage device. The external storage device 204 stores computer programs and data for causing the CPU 200 to execute each process described later as being performed by the information processing apparatus 100.

The display device 205 is, for example, a liquid crystal display, an organic EL display, or the like, and displays information necessary for the user. The input device 206 is, for example, a keyboard, a mouse, a touch panel, a button, or the like, and receives necessary input from the user.

Note that the imaging apparatus 101 and the user terminal device 102 also have a similar hardware configuration provided with a CPU, a ROM, and a RAM different from those of the information processing apparatus 100. In addition, the imaging apparatus 101 also includes an imaging device that converts light from the outside world into electronic image data or electronic video data by a known optical technology.

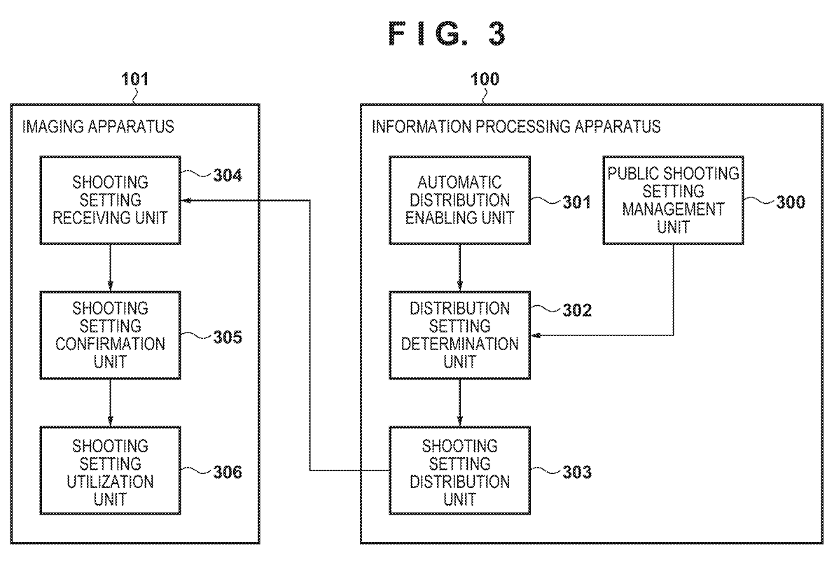

Next, a functional configuration example of the information processing apparatus 100 and the imaging apparatus 101 according to the present embodiment will be described with reference to FIG. 3.

### Functional Configuration of Information Processing Apparatus

The information processing apparatus 100 includes a public shooting setting management unit 300, an automatic distribution enabling unit 301, a distribution setting determination unit 302, and a shooting setting distribution unit 303.

The public shooting setting management unit 300 receives a shooting setting and shooting setting related information related to the shooting setting uploaded from the user terminal device 102 or the imaging apparatus 101 to the information processing apparatus 100, and stores them as a public shooting setting. The shooting setting is a setting value that can be set by a camera. The shooting setting can include at least one of shooting parameters such as a shooting mode and/or a shutter speed, development parameters for adjusting the color tone of an image after shooting, a shooting setting ID for uniquely identifying the shooting setting, a shooting setting name, and the like. The shooting setting related information can include at least one of creator information of the shooting setting, description information of the shooting setting, an example image captured using the shooting setting, equipment information at the time of capturing the example image, a recommended shooting scene for using the shooting setting, and the like. Note that the contents of the shooting setting and the shooting setting related information are merely examples, and limitation is not made thereto.

The automatic distribution enabling unit 301 manages distribution conditions for enabling automatic distribution of the shooting setting to the imaging apparatus 101. The automatic distribution enabling unit 301 receives an automatic distribution request from the user terminal device 102 or the imaging apparatus 101, and based on information included in the automatic distribution request, creates and records a distribution condition for determining whether or not the shooting setting should be automatically distributed to the imaging apparatus 101. The automatic distribution request is information including a device ID capable of uniquely identifying the imaging apparatus 101 and an automatic distribution flag representing whether or not automatic distribution should be performed. At that time, for example, information regarding the imaging apparatus 101, such as model information of the imaging apparatus 101 and information on functions possessed, may be included in the automatic distribution request.

Further, not only the information regarding the imaging apparatus 101 but also information regarding a user who owns the imaging apparatus 101 may be included in the automatic distribution request. For example, owned equipment information of shooting equipment such as lenses and accessories owned by the user may be included in the automatic distribution request. Furthermore, user preference information, such as information on a shooting setting creator favored by the user who owns the imaging apparatus 101 (for example, a photographer favored by the user) and information on a shooting scene favored by the user, may be included in the automatic distribution request. The automatic distribution request from the user terminal device 102 or the imaging apparatus 101 may include timing information so as to be transmitted from the user terminal device 102 or the imaging apparatus 101 to the information processing apparatus 100 at a timing when the user desires automatic distribution. That is, the timing information is information indicating a timing when the user desires automatic distribution.

The distribution setting determination unit 302 detects that a public shooting setting has been added to the public shooting setting management unit 300, and determines an imaging apparatus to which the added public shooting setting is to be distributed based on the distribution condition set by the automatic distribution enabling unit 301. An imaging apparatus to which distribution should be performed is identified from the device ID for which the automatic distribution flag is enabled, and imaging apparatuses as distribution target candidates are extracted.

In addition, the distribution targets may be narrowed down from the information recorded in the distribution conditions. For example, when the model information of the imaging apparatus or information on the functions possessed is included in the distribution condition, it is determined from this information whether or not the added public shooting setting is usable in the target imaging apparatus, and the public shooting setting may be distributed by narrowing down to compatible imaging apparatuses.

Also, when the owned equipment information is included in the distribution condition, the equipment information at the time of capturing the example image, which is recorded in the shooting setting related information of the added public shooting setting, is acquired, and when that equipment information is included in the owned equipment information, the public shooting setting may be distributed to that imaging apparatus.

Furthermore, when the user preference information is included in the distribution condition, the distribution may be limited to public shooting settings that match the preference information. For example, when a shooting setting creator favored by the user is in the distribution condition, the public shooting setting may be distributed to the imaging apparatus when the creator of the public shooting setting matches the shooting setting creator favored by the user. When a shooting scene favored by the user is in the distribution condition, the public shooting setting may be distributed to the imaging apparatus when a recommended shooting scene of the public shooting setting matches the shooting scene favored by the user.

Regarding the narrowing down by these distribution conditions, a distribution target may be set when all distribution conditions are satisfied, or distribution may be performed when only a part thereof is satisfied.

In addition, the distribution setting determination unit 302 generates setting display information processed for checking the shooting setting related information of the public shooting setting on the distribution target imaging apparatus. The setting display information is generated by generating a processed example image obtained by converting an example image of the shooting setting related information into an image size and resolution suitable for display on the imaging apparatus, and replacing the example image of the shooting setting related information therewith. At this time, information on a display device provided in each imaging apparatus may be acquired from model information of the distribution target imaging apparatus, and processed example images converted into an image size and resolution matching the display device may be respectively generated.

However, the generation method of the setting display information is merely an example, and limitation is not made thereto. For example, the setting display information may be generated by generating summarized description information summarized from description information of the shooting setting included in the shooting setting related information, and replacing the description information of the shooting setting of the shooting setting related information therewith.

Further, when the size of the display device of the imaging apparatus is small, only a part of the shooting setting related information may be extracted and used as the setting display information. In that case, setting display information prioritizing a part of the shooting setting related information that matches a distribution condition may be generated. For example, when distributing a public shooting setting that matches owned equipment information (for example, information on an owned lens or the like), the setting display information may be generated so as to include equipment information at the time when the example image was captured. Alternatively, when distributing a public shooting setting that matches a shooting setting creator favored by the user, the setting display information may be generated so as to include information on the creator of the public shooting setting. At that time, a shooting setting creator favored by the user may be configured to be followable, and a followed shooting setting creator may be set as a shooting setting creator favored by the user.

Alternatively, when distributing a public shooting setting that matches a shooting scene favored by the user, the setting display information may be generated so as to include information on a recommended shooting scene.

The shooting setting distribution unit 303 distributes the shooting setting and the setting display information to the imaging apparatus 101 based on the contents determined by the distribution setting determination unit 302. Here, the shooting setting distribution unit 303 directly transmits the shooting setting and the setting display information to the imaging apparatus 101, but limitation is not made thereto. For example, the shooting setting distribution unit 303 may distribute to the imaging apparatus 101 notification information representing that there are a distributable shooting setting and setting display information. In that case, the imaging apparatus 101 may select a shooting setting and setting display information desired to be distributed based on the notification information, and transmit the selection result to the information processing apparatus 100. Then, the information processing apparatus 100 transmits the shooting setting, the setting display information, and information regarding the public shooting setting to the imaging apparatus 101 based on the selection result, whereby the imaging apparatus 101 may acquire the shooting setting and the setting display information desired to be distributed.

### Functional Configuration of Imaging Apparatus

The imaging apparatus 101 includes a shooting setting receiving unit 304, a shooting setting confirmation unit 305, and a shooting setting utilization unit 306.

The shooting setting receiving unit 304 receives and records the shooting setting and the setting display information distributed from the shooting setting distribution unit 303 of the information processing apparatus 100. Note that the shooting setting receiving unit 304 may receive, from the shooting setting distribution unit 303, notification information representing that there are a distributable shooting setting and setting display information, and may request from the information processing apparatus 100 a shooting setting and setting display information for which distribution is desired based on the notification information. Then, the shooting setting and the setting display information distributed from the information processing apparatus 100 in response to the request may be acquired. In that case, a timing for acquiring the shooting setting, such as during battery charging or during network connection, may be settable on the imaging apparatus 101 side.

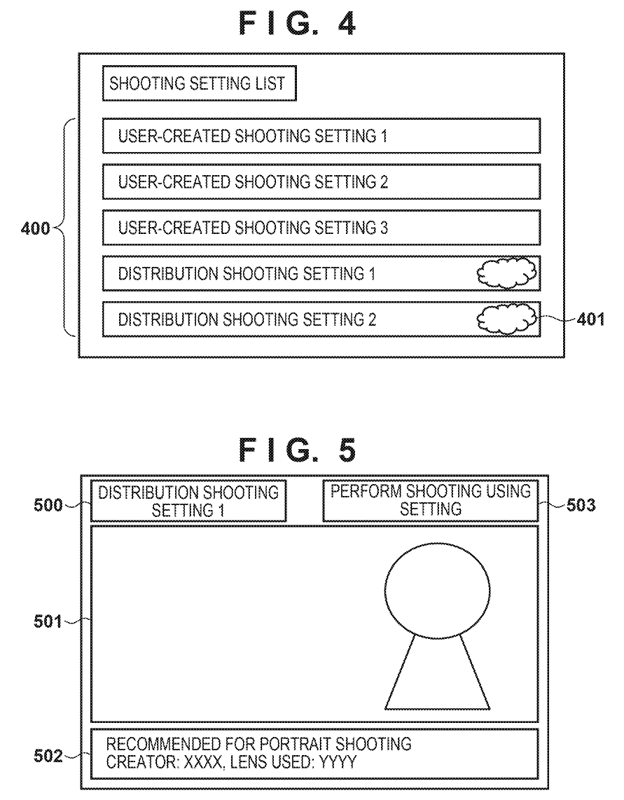

The shooting setting confirmation unit 305 generates and displays a shooting setting confirmation screen for the user to confirm the shooting setting, using the setting display information received and recorded by the shooting setting receiving unit 304. Here, an example of screens displayed on the imaging apparatus 101 will be described with reference to FIG. 4 and FIG. 5. First, the user refers to a shooting setting list screen shown in FIG. 4 and selects shooting information to be confirmed from among a displayed shooting setting list 400. At that time, a distribution icon 401 may be displayed on the shooting setting list screen so that it can be recognized that the shooting setting has been automatically distributed.

When the user selects the shooting information to be confirmed, a shooting setting confirmation screen shown in FIG. 5 is displayed. Here, it is assumed that distribution shooting setting 1 is selected. On the shooting setting confirmation screen, a shooting setting name 500 included in the shooting setting (distribution shooting setting 1 here) and a processed example image 501 included in the setting display information are displayed. Furthermore, information 502 other than the processed example image of the setting display information is displayed as a description area of the shooting setting. In addition, a setting use button 503 for selecting to perform shooting using the shooting setting is displayed on the shooting setting confirmation screen.

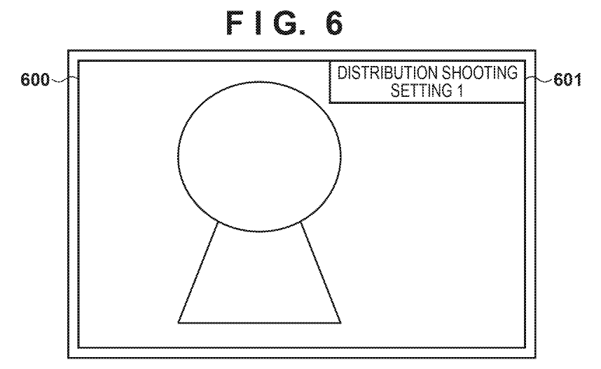

The shooting setting utilization unit 306 sets the shooting setting selected for use in shooting in the shooting setting confirmation unit 305 to the imaging apparatus 101 to enable shooting. Here, an example of a screen when using the shooting setting is shown in FIG. 6. When using the shooting setting, a shooting setting name 601 currently being used (distribution shooting setting 1 here) is superimposed on an image 600 to be captured and displayed. As a result, the user can perform shooting while recognizing what kind of setting the shooting setting currently in use is.

Note that each screen display on the imaging apparatus is merely an example, and the screen configuration and the display position are not limited.

### Processing

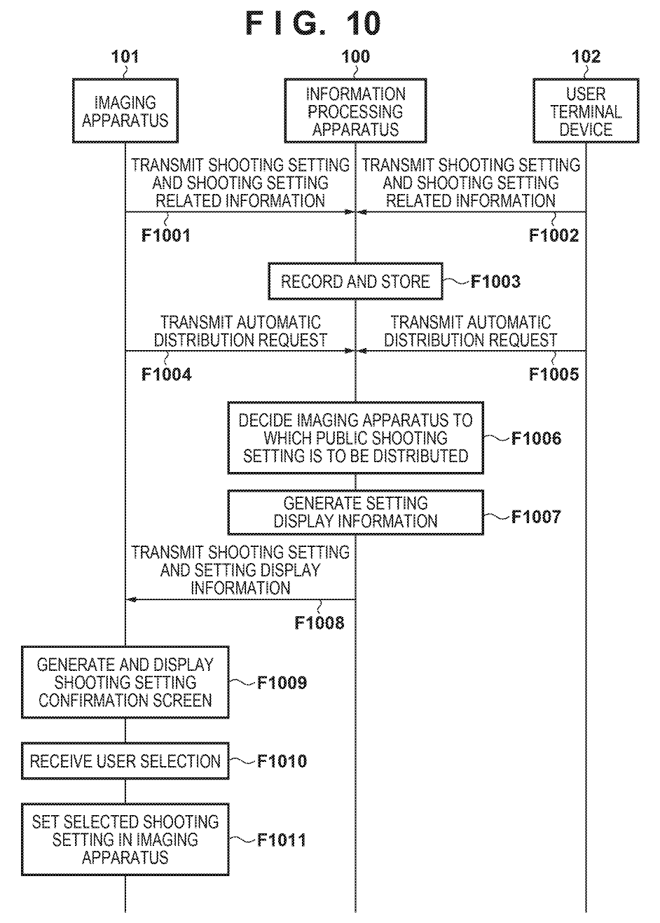

Next, processing executed by the information processing system 10 according to the present embodiment will be described with reference to a processing sequence diagram of FIG. 10. In step F1001, the user transmits/uploads a shooting setting and shooting setting related information created by the user to the information processing apparatus 100 via the imaging apparatus 101. In step F1002, the user transmits/uploads the shooting setting and the shooting setting related information created by the user to the information processing apparatus 100 via the user terminal device 102. The user can operate the imaging apparatus 101 and/or the user terminal device 102 to upload the created shooting setting and shooting setting related information.

In step F1003, the information processing apparatus 100 records and stores the received shooting setting and shooting setting related information. The information processing apparatus 100 can receive and manage various shooting settings and shooting setting related information from various users. In step F1004, the user transmits an automatic distribution request to the information processing apparatus 100 via the imaging apparatus 101. In step F1005, the user transmits an automatic distribution request to the imaging apparatus 101 of the user to the information processing apparatus 100 via the user terminal device 102. Processing of step F1004 or step F1005 may be alternatives, and the user may transmit the automatic distribution request to the imaging apparatus 101 of the user by operating either the imaging apparatus 101 or the user terminal device 102.

In step F1006, the information processing apparatus 100 creates a distribution condition based on the received automatic distribution request. Then, the information processing apparatus 100 detects that a public shooting setting has been added. This means that a public shooting setting has been newly uploaded by processing such as step F1001 or step F1002. Note that in the present embodiment, the automatic distribution requests of step F1004 and step F1005 are received by the information processing apparatus 100 after step F1001 and step F1002, but a public shooting setting may be newly uploaded after processing of step F1004 and step F1005. Furthermore, the information processing apparatus 100 determines the imaging apparatus 101 to which the added public shooting setting is to be distributed based on the created distribution condition.

In step F1007, the information processing apparatus 100 generates setting display information processed for checking the shooting setting related information of the public shooting setting on the distribution target imaging apparatus 101. In step F1008, the information processing apparatus 100 distributes the shooting setting and the setting display information to the distribution target imaging apparatus 101. In step F1009, the imaging apparatus 101 generates and displays a shooting setting confirmation screen for the user to confirm the shooting setting, based on the setting display information received from the information processing apparatus 100.

In step F1010, the imaging apparatus 101 receives a user selection of the shooting setting in response to pressing of the setting use button 503 by the user who has viewed the shooting setting confirmation screen. In step F1011, the shooting setting selected for use in shooting is set in the imaging apparatus 101 to enable shooting. The above is the processing sequence of FIG. 10.

As described above, according to the present embodiment, by the user requesting automatic distribution of a shooting setting from the imaging apparatus or the user terminal in advance, the shooting setting can be automatically used on the imaging apparatus when a new shooting setting is made public. Further, by performing confirmation display of the shooting setting matching the imaging apparatus, the new shooting setting can be easily confirmed on the imaging apparatus.

### SECOND EMBODIMENT

In the first embodiment, an example in which a shooting setting can be automatically used on the imaging apparatus when a new shooting setting is made public has been described. In the present embodiment, in addition to that, an example in which shooting settings to be distributed are narrowed down according to a shooting history will be described. Since a configuration example of an information processing system and a hardware configuration example of each apparatus according to the present embodiment are similar to those of the first embodiment, descriptions thereof are omitted.

### Functional Configuration

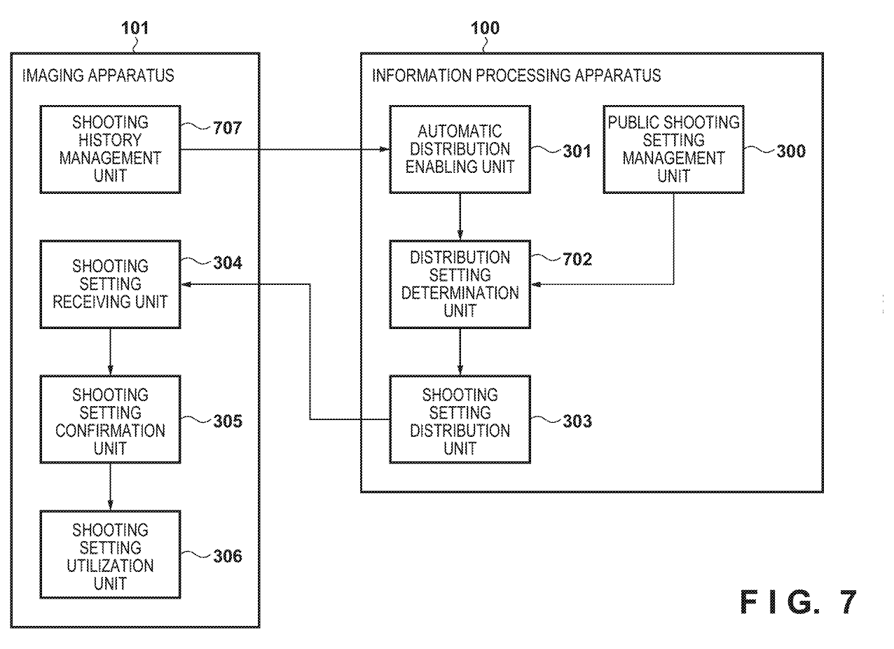

A functional configuration example of the information processing apparatus 100 and the imaging apparatus 101 according to the present embodiment will be described using the block diagram of FIG. 7. The information processing apparatus 100 according to the present embodiment has a configuration similar to that of the first embodiment described with reference to FIG. 3. The imaging apparatus 101 according to the present embodiment includes a shooting setting receiving unit 304, a shooting setting confirmation unit 305, a shooting setting utilization unit 306, and a shooting history management unit 707. Components other than the shooting history management unit 707 are similar to those of the first embodiment, and thus descriptions thereof are omitted.

The shooting history management unit 707 manages a history of shooting by the imaging apparatus 101 as a shooting history, and determines an automatic distribution request to be transmitted to (the automatic distribution enabling unit 301 of) the information processing apparatus 100 based on the shooting history. The shooting history management unit 707 records, as a shooting history, information on shooting equipment used for shooting and a captured shooting scene for each past shooting.

The imaging apparatus 101 regards the shooting equipment recorded in the shooting history as the user's owned equipment, and sets a list of the shooting equipment in the shooting history as owned shooting equipment information of the automatic distribution request. Also, the shooting scene recorded in the shooting history is determined as a shooting scene favored by the user as user preference information of the automatic distribution request. Note that the information recorded as the shooting history is not limited to this, and the information included in the automatic distribution request is also not limited to this.

Also, in the present embodiment, an example in which the automatic distribution request to be transmitted to (the automatic distribution enabling unit 301 of) the information processing apparatus 100 is determined based on the shooting history has been described, but the present disclosure is not limited to this example. For example, the imaging apparatus 101 may be configured to periodically transmit shooting history information to the information processing apparatus 100, so that the information processing apparatus 100 side uses it for determination of a distribution condition by the automatic distribution enabling unit 301.

As described above, according to the present embodiment, when the user requests automatic distribution of a shooting setting from the imaging apparatus, a shooting setting based on past shooting is distributed without the user specifying a distribution condition.

### THIRD EMBODIMENT

In the present embodiment, in addition to the configuration of the first embodiment, an example in which a degree of matching between setting display information and an actual shooting situation is verified and a shooting assistance display is performed during shooting using the shooting setting will be described. Since a configuration example of an information processing system and a hardware configuration example of each apparatus according to the present embodiment are similar to those of the first embodiment, descriptions thereof are omitted.

### Functional Configuration

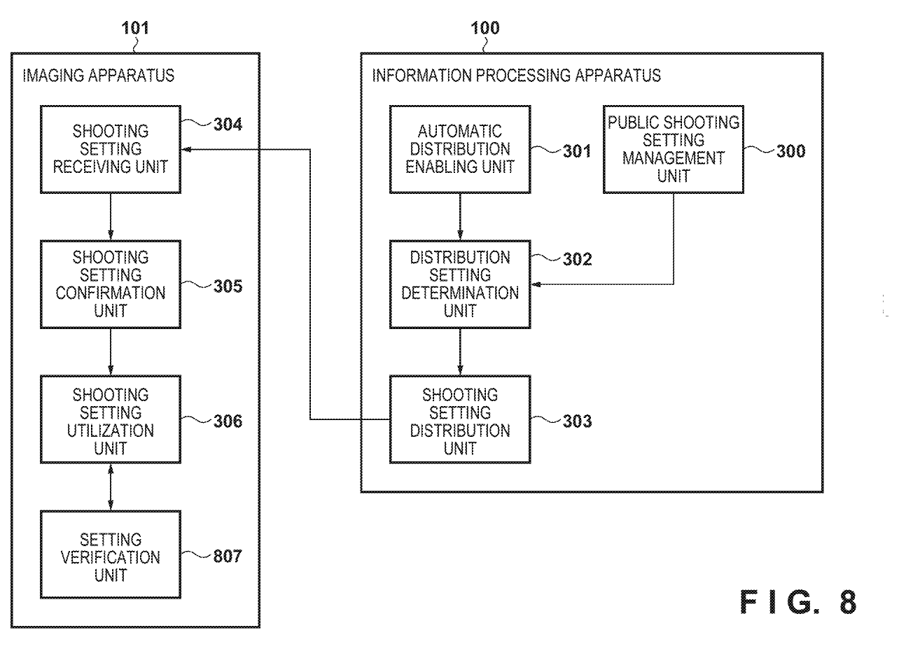

A functional configuration example of the information processing apparatus 100 and the imaging apparatus 101 according to the present embodiment will be described using the block diagram of FIG. 8. The information processing apparatus 100 according to the present embodiment has a configuration similar to that of the first embodiment described with reference to FIG. 3. The imaging apparatus 101 according to the present embodiment includes a shooting setting receiving unit 304, a shooting setting confirmation unit 305, a shooting setting utilization unit 306, and a setting verification unit 807. Components other than the setting verification unit 807 are similar to those of the first embodiment, and thus descriptions thereof are omitted.

The setting verification unit 807 verifies a degree of matching between setting display information and an actual shooting situation, based on the setting display information of the shooting setting being used for shooting. When equipment information (for example, information on an owned lens or the like) is included in the setting display information, it is verified whether or not it matches equipment used for shooting. Also, when a recommended shooting scene is included in the setting display information, it is verified whether or not it matches a shooting scene to be captured. The setting verification unit 807 notifies the shooting setting utilization unit 306 of a verification result, and the shooting setting utilization unit 306 performs a shooting setting assistance display which is auxiliary information for performing shooting using the shooting setting, based on the verification result.

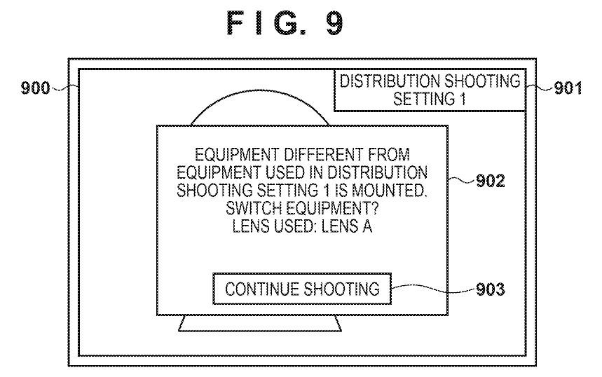

Here, an example of a screen on which the shooting setting assistance display according to the present embodiment is performed will be described with reference to FIG. 9. FIG. 9 is an example in a case where lens information is included as equipment information of the setting display information, and is an example in a case where a lens included in the lens information is different from a mounted lens. An image 900 to be captured (for example, a live view image) and a shooting setting name 901 currently being used are similar to the example of FIG. 6. The shooting setting assistance display 902 superimposedly displays information indicating that a lens used in the example of the shooting setting and the mounted lens are different. The information may be information for prompting or confirming switching of the lens.

The shooting setting assistance display 902 includes a button 903 for the user to select to continue shooting. When the user exchanges the lens according to the shooting setting assistance display 902, the setting verification unit 807 detects information on the exchanged lens, and upon verification that the lens used in the example of the shooting setting and the mounted lens match, the shooting setting assistance display 902 is erased. In a case of performing shooting as is without exchanging the lens, shooting can be continued by erasing the shooting setting assistance display 902 by pressing the button 903.

Note that the content of the shooting setting assistance display is merely an example, and limitation is not made thereto. For example, when a recommended shooting scene included in the setting display information and an actual shooting scene are different, information indicating that fact can be displayed. In that case, what kind of scene the current shooting scene is may be recognized from the image 900 to be captured (for example, a live view image), and a comparison with the recognized shooting scene may be performed. Also, when information indicating that the shooting setting is recommended for a specific subject is included in the setting display information, a warning may be displayed when a subject different from the specific subject is currently being focused on. Also, when information on a recommended subject distance is included in the setting display information, a warning may be displayed when the subject is out of the recommended distance. Note that the screen display on the imaging apparatus is merely an example, and the screen configuration and the display position are not limited to this.

As described above, according to the present embodiment, when the user performs shooting using a shooting setting with the imaging apparatus, the user can be assisted in using the shooting setting based on the setting display information. Therefore, it becomes easy for the user to perform shooting suitable for the shooting setting.

According to the present disclosure, it becomes possible to easily use a new shooting setting.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-065200, filed Apr. 10, 2025 which is hereby incorporated by reference herein in its entirety.

What is claimed is:

1. An information processing apparatus comprising:
a receiving unit configured to receive one or more public shooting settings;
a management unit configured to store in a storage unit and manage the one or more public shooting settings;
a decision unit configured to, in a case where a new public shooting setting is received by the receiving unit and added to the storage unit, decide an imaging apparatus to which information regarding the new public shooting setting is to be distributed based on a distribution condition; and
a distribution unit configured to perform distribution to the imaging apparatus decided by the decision unit.

2. The information processing apparatus according to claim 1,
wherein the receiving unit further receives a distribution request for a public shooting setting from an imaging apparatus, and
the information processing apparatus further comprises a creation unit configured to create the distribution condition based on information included in the distribution request.

3. The information processing apparatus according to claim 2,
wherein the distribution request includes a device ID capable of uniquely identifying an imaging apparatus and an automatic distribution flag representing whether or not automatic distribution should be performed.

4. The information processing apparatus according to claim 3,
wherein the distribution request further includes at least one of model information of the imaging apparatus, shooting equipment information owned by a user of the imaging apparatus, information on a shooting setting creator favored by a user of the imaging apparatus, information on a shooting scene favored by a user of the imaging apparatus, and timing information indicating a timing when a user of the imaging apparatus desires automatic distribution.

5. The information processing apparatus according to claim 1,
wherein the public shooting setting stored in the storage unit includes a shooting setting and shooting setting related information related to the shooting setting.

6. The information processing apparatus according to claim 5,
wherein the shooting setting includes at least one of a shooting parameter, a development parameter for adjusting a color tone of an image after shooting, a shooting setting ID for uniquely identifying the shooting setting, and a shooting setting name.

7. The information processing apparatus according to claim 6,
wherein the shooting parameter includes at least one of a shooting mode and a shutter speed.

8. The information processing apparatus according to claim 5,
wherein the shooting setting related information includes at least one of creator information of the shooting setting, description information of the shooting setting, an example image captured using the shooting setting, equipment information at a time when the example image was captured, and a recommended shooting scene for using the shooting setting.

9. The information processing apparatus according to claim 5, further comprising:
a generation unit configured to generate setting display information for confirming the shooting setting on the imaging apparatus based on the shooting setting related information,
wherein the information regarding the new public shooting setting includes the shooting setting included in the public shooting setting and the setting display information generated from the shooting setting related information included in the public shooting setting.

10. The information processing apparatus according to claim 9,
wherein, in a case where the shooting setting related information includes an example image captured using the shooting setting,
the generation unit generates the setting display information by generating a processed example image obtained by converting the example image into an image size and a resolution suitable for display on the imaging apparatus.

11. The information processing apparatus according to claim 9,
wherein, in a case where the shooting setting related information includes description information of the shooting setting,
the generation unit generates the setting display information by generating summarized description information summarized from the description information.

12. An imaging apparatus capable of communicating with an information processing apparatus, comprising:
a transmission unit configured to transmit to the information processing apparatus a distribution request for a public shooting setting managed by the information processing apparatus; and
a receiving unit configured to receive, in response to a new public shooting setting being added to the information processing apparatus, information regarding the new public shooting setting distributed from the information processing apparatus according to a distribution condition based on the distribution request.

13. The imaging apparatus according to claim 12,
wherein the public shooting setting includes a shooting setting and shooting setting related information related to the shooting setting, and
the information regarding the new public shooting setting includes the shooting setting and setting display information generated from the shooting setting related information for confirming the shooting setting on the imaging apparatus.

14. The imaging apparatus according to claim 13,
further comprising a control unit configured to generate a shooting setting confirmation screen for a user to confirm the shooting setting using the setting display information and causing a display unit to display the shooting setting confirmation screen.

15. The imaging apparatus according to claim 14,
wherein the shooting setting confirmation screen includes a shooting setting name, a processed example image included in the setting display information, and a button for selecting to perform shooting using the shooting setting.

16. The imaging apparatus according to claim 12,
further comprising a control unit configured to cause a display unit to display a shooting setting list screen including a distribution icon indicating that a shooting setting has been automatically distributed.

17. The imaging apparatus according to claim 12,
further comprising a decision unit configured to decide the distribution request to be transmitted to the information processing apparatus based on a shooting history in the imaging apparatus.

18. The imaging apparatus according to claim 12, further comprising:
a verification unit configured to verify a degree of matching between setting display information and an actual shooting situation based on setting display information of a shooting setting being used for shooting; and
a control unit configured to cause a display unit to display auxiliary information for performing shooting using the shooting setting based on a verification result by the verification unit.

19. A control method for an information processing apparatus, comprising:
receiving one or more public shooting settings;
managing the one or more public shooting settings by storing the one or more public shooting settings in a storage unit;
deciding, in a case where a new public shooting setting is received and added to the storage unit, an imaging apparatus to which the new public shooting setting is to be distributed based on a distribution condition; and
performing distribution to the decided imaging apparatus.

20. A control method for an imaging apparatus capable of communicating with an information processing apparatus, comprising:
transmitting to the information processing apparatus a distribution request for a public shooting setting managed by the information processing apparatus; and
receiving, in response to a new public shooting setting being added to the information processing apparatus, information regarding the new public shooting setting distributed from the information processing apparatus according to a distribution condition based on the distribution request.

21. A non-transitory computer-readable storage medium storing a program for causing a computer to execute a control method for an information processing apparatus, the control method comprising:
receiving one or more public shooting settings;
managing the one or more public shooting settings by storing the one or more public shooting settings in a storage unit;
deciding, in a case where a new public shooting setting is received and added to the storage unit, an imaging apparatus to which the new public shooting setting is to be distributed based on a distribution condition; and
performing distribution to the decided imaging apparatus.

22. A non-transitory computer-readable storage medium storing a program for causing a computer to execute a control method for an imaging apparatus capable of communicating with an information processing apparatus, the control method comprising:
transmitting to the information processing apparatus a distribution request for a public shooting setting managed by the information processing apparatus; and
receiving, in response to a new public shooting setting being added to the information processing apparatus, information regarding the new public shooting setting distributed from the information processing apparatus according to a distribution condition based on the distribution request.
